(19) United States
(12) Patent Application Publication
(10) Pub. No.: US 2014/0209410 A1
(43) Pub. Date: Jul. 31, 2014

(54) Multi-Orientable Device for Securing Portable Steps

(71) Applicant: KAPARAZOOM, SLU, Valencia (ES)

(72) Inventor: Javier Villar Cloquell, Valencia (ES)

(21) Appl. No.: 14/237,285

(22) PCT Filed: Aug. 3, 2012
(86) PCT No.: PCT/ES2012/000223

§ 371 Date: Apr. 7, 2014

(30) Foreign Application Priority Data
Aug. 5, 2011 (ES) P201100929

(51) Int. Cl. E06C 7/18

(52) U.S. Cl. CPC E06C 7/188
USPC 182/107

(57) ABSTRACT

Device (1) for securing portable steps in building and civil engineering works, which enhances the safety thereof, minimizing the risk of falling. This device is affixed to the longitudinal members (4) or crossmembers (5) of the steps and to the support article (3), using clips. In order to affix the clips securely, the device (1) rotates and moves the clips in the three spatial axes (X,Y,Z). In order for it to be possible to correctly affix the device to different articles, be these of different form or material, there are likewise different support elements (28). The device is removable and more than one thereof can be used on the same steps. This device secures portable steps to articles such as floor slabs, sloping roofs, pillars, posts or trees.

### FIELD OF THE ART

The present invention is comprised within the applications intended for the field of building and civil engineering works.

### BACKGROUND OF THE INVENTION

The high risks involved in the use of portable steps have led to the development of different systems to prevent or minimize possible accidents in building and civil engineering works.

The state of the art shows different solutions such as patent WO 2010/011795 which discloses a safety mechanism for anchoring on cylindrical bodies, namely, a tree or a lamppost, etc. Furthermore, patent GB 2438029 provides a system built into the steps enabling it to be anchored to elements at different angles, but parallel to the steps and is operated from the bottom thereof. On the other hand, patent FR 2791731 shows a fastening system for circular elements with clips, that is fitted on the rungs or longitudinal members of the steps, enabling the clips to be oriented.

In order to properly secure these safety systems, the midpoint of the clips has to coincide with the midpoint of the object to be secured and the central axis of the steps has to coincide with the midpoint of the object to be secured. In actual practice, this situation is very complicated and only succeeds for circular and vertical objects, such as posts. Using these devices for securing to trees or branches, where the geometry varies, is very difficult or impossible to properly secure.

There are no known devices that can guide and/or move elements for securing a portable steps relative to the object onto which it is supported on the three spatial Cartesian axes, resulting in secure and easy fastening.

### OBJECT OF THE INVENTION

To improve the safety of portable steps using a new accessory for anchoring the steps, thereby managing to avoid accidents.

### DETAILED DESCRIPTION OF THE INVENTION

Every year many workers are killed or seriously injured while using portable steps to carry out work. The fact that steps are such a simple item, the possibility of making improvements thereto has been dispensed with. In this regard, using portable steps requires them to be secured so as to ensure the safety of those working thereon.

The new multi-orientable device for securing portable steps, effectively resolves the instability of the steps. This new device allows the stairs incorporated in conventional steps to be secured and anchored quickly, efficiently and safely, and is removable compared to any type of object on which it is supported, either, cylindrical, polygonal bodies and all kinds of parameters, irrespective of its spatial orientation.

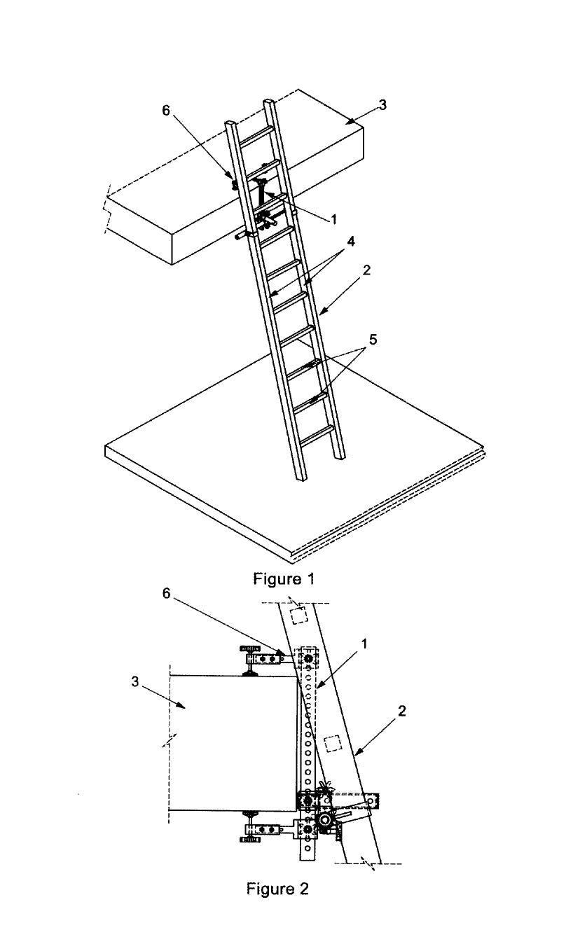

The multi-orientable device (1) (FIGS. 1 and 2) is affixed to the longitudinal members (4) (FIG. 1) or the cross-members (5) (FIG. 1) of the steps. The structure and arrangement of the components provide it with the capacity to move and rotate on 3 Cartesian axes (X, Y, Z) making it possible to position the clips (6) (FIGS. 1 and 2) correctly in order to press the support article (3) (FIGS. 1 and 2), and thereby secure the steps.

This device (1) (FIGS. 1 and 2), is removable, therefore, it can be placed and removed from the steps (2) (FIGS. 1 and 2).

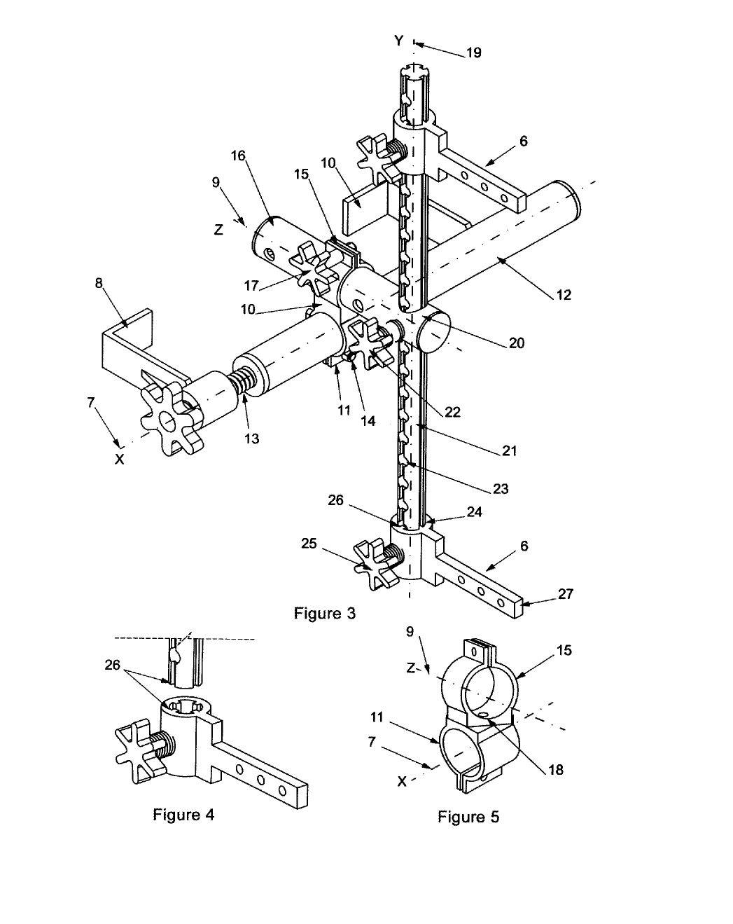

To achieve this translational and rotational capacity on three axes (X, Y, Z), and secure to the steps and the support article, the following means are provided:
Securing the device (1) (FIG. 1) to the steps. The new multi-orientable device is secured by using two jaws (8) (FIG. 3), one of which is integrally affixed to the X tube (12) (FIG. 3) and the other is integrally affixed to a conventional clamping system (13) (FIG. 3), such as a worm gear. By placing these jaws between the longitudinal members or between two rungs and generating the clamping, the device remains secured to the steps.
Translation and rotation on the X axis. This new device has means for moving and rotating the fastening clips (6) (FIG. 3) relative to the X axis (7) (FIG. 3), the X axis being defined by the virtual line formed between the jaws (8) (FIG. 3). The translational and rotational movement relative to the X axis (7) (FIG. 3) of the clips is provided with conventional means such as a double clamp (10) (FIG. 3). The X clamp (11) (FIG. 3) integrally affixed to the double clamp (10) (FIG. 3), is oriented towards the X axis (7) (FIG. 3) and has a clearance fit with the tube (12) (FIG. 3), enabling its translation and rotation relative to the X axis (7) (FIG. 3). The X clamp has conventional fastening means (14) (FIG. 3) such as a set screw, quick-release crank or pins.
Translation and rotation on the Z axis. This new device has means for moving and rotating the fastening clips (6) (FIG. 3) relative to the Z axis (9) (FIG. 3). The translational and rotational movement relative to the Z axis (9) (FIG. 3) of the clips is provided with conventional means such as a double clamp (10) (FIG. 3). The Z clamp (15) (FIG. 3, integrally affixed to the double clamp (10) (FIG. 3), is oriented towards the Z axis (9) (FIG. 3) and has a clearance fit with the Z tube (16) (FIG. 3), enabling its translation and rotation relative to the Z axis (9) (FIG. 3). The Z clamp has conventional fastening means (17) (FIG. 3) such as a set screw, quick-release crank or pins.
Variation of the angle between the X and Z axis. Versions are provided in which the angle between the X axis (7) (FIG. 5) and Z axis(9) (FIG. 5) varies, being different to 90° . This variation of the angle between the X axis and Z axis is provided with conventional means such as a double clamp with a rotation shaft (18) (FIG. 5) aligned to the center of the X clamp (11) (FIG. 5) and the Z clamp(15) (FIG. 5).
Translation and rotation on the Y axis. This new device has means for moving and rotating the fastening clips (6) (FIG. 3) relative to the Y axis (19) (FIG. 3). The translational and rotational movement relative to the Y axis (19) (FIG. 3) of the clips is provided with conventional means such as the Z tube (16) (FIG. 3) that has a through hole (20) (FIG. 3) comprising a clearance fit relative to the circular Y bar (21) (FIG. 3), enabling its translation and rotation relative to the Y axis (19) (FIG. 3), the Z tube being provided with conventional fastening means (22) (FIG. 3) such as a set screw, quick-release crank or pins.
Securing the Y bar. To secure the movement in predefined positions and to restrict rotation on the Y axis (19) (FIG. 3) of the Y bar (21) (FIG. 3), there is at least one through hole (23) (FIG. 3), the screw (22) (FIG. 3) acting as a pin, thereby securing the Y bar (21) (FIG. 3).
Translation and securing of clips. The clips (6) (FIG. 3) are moved along the Y bar (21) (FIG. 3) to fit the dimensions of the support article (3) (FIG. 1) on which they have to exert pressure, the clips being fixed to the bar to maintain pressure. This translational movement is provided with conventional means such as a guide through-hole (24) (FIG. 3) in the clips, which has a clearance fit relative to the Y bar (21) (FIG. 3), enabling its translation along the Y bar. The clips are provided with conventional fastening means (25) (FIG. 3) such as a set screw, quick-release crank or pins.
Rotation of the clips. The clips (6) (FIG. 3) rotate relative to the Y bar (21) (FIG. 3) on the Y axis (19) (FIG. 3), in predefined positions. This rotation of the clips (6) (FIG. 3) is provided with conventional means with at least one guide (26) (FIGS. 3 and 4) with an inlet and outlet on the clips (6) (FIG. 3) and the Y bar (19) (FIG. 3).

Provision has been made for a version to achieve this translation and rotation capacity on three axes (X, Y, Z), and to secure to the steps and the support article. This version of the multi-orientable safety device for securing portable steps enables the portable steps to be secured in situations where there is an object between the steps and the support article, which impedes placement of the device discussed above. This variation replaces the mechanical elements between the bar that guides the clips and the steps with a flexible element enabling any type of spatial orientation on the axes (X, Y, Z). To permanently attach the clips to the steps, at least one conventional flexible connector means (43) (FIG. 11) is used, such as a rope, strap or cable. The flexible connector element is attached to the steps using the longitudinal members or cross-members with at least one conventional connector element (44) (FIG. 11) such as a carabiner, clamp or surrounding the flexible coupling (43) (FIG. 11). Said flexible connector element (43) (FIG. 11) is provided with at least one conventional tensioner (45) (FIG. 11) such as a tensioning lathe or belt tensioner or turnbuckle. The bar (42) (FIG. 11) is provided with means for moving the clips (41) (FIG. 11) along the bar and securing them. This translational movement is provided with conventional means such as a guide through-hole (46) (FIG. 11) in the clips, which has a clearance fit relative to the bar (42) (FIG. 11). The bar has an integral attachment point (47) (FIG. 11), wherein the flexible connector element (43) (FIG. 11) is attached to the bar (42) (FIG. 11). This attachment point (47) (FIG. 11) is arranged with conventional elements such as an eyebolt, screws or clip. The clips (41) (FIG. 11) comprise conventional fastening means (48) (FIG. 11) such as a set screw, quick-release crank or pins.

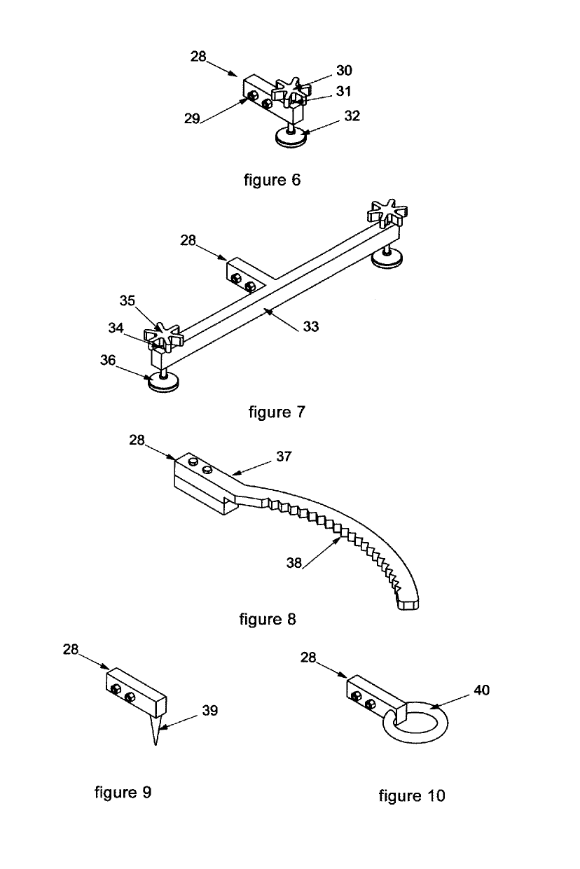

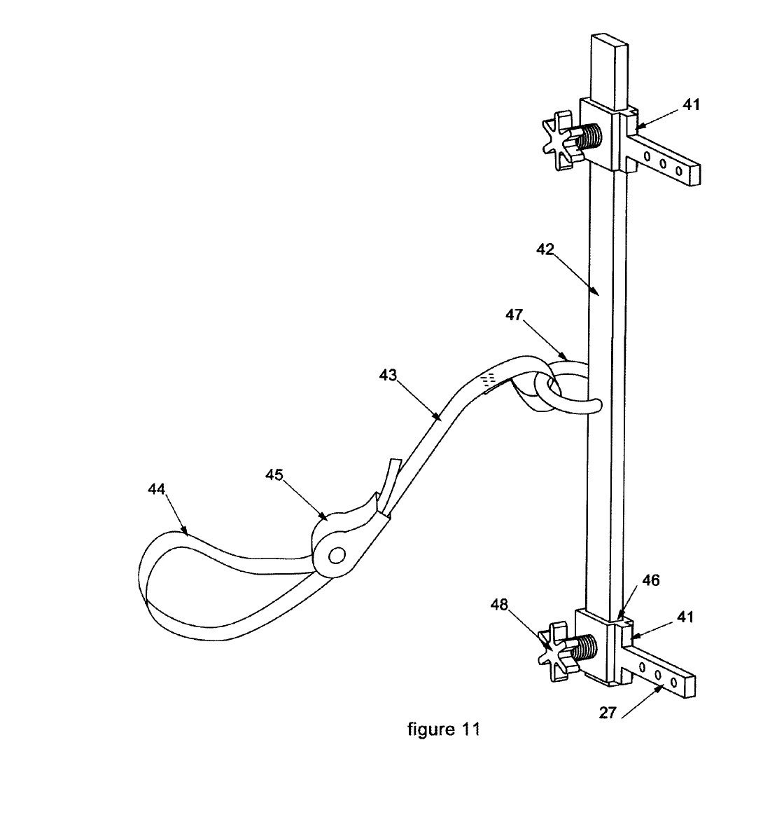

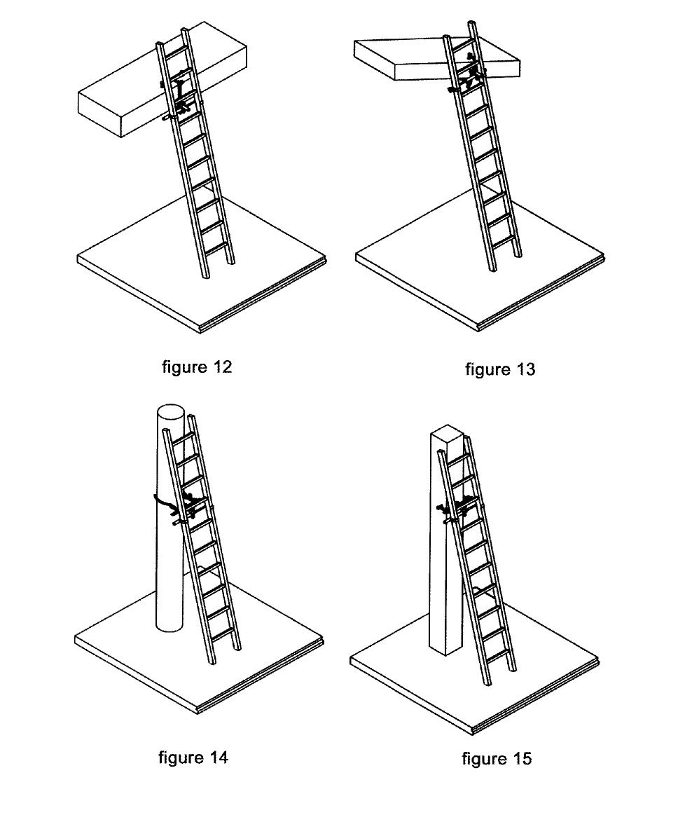

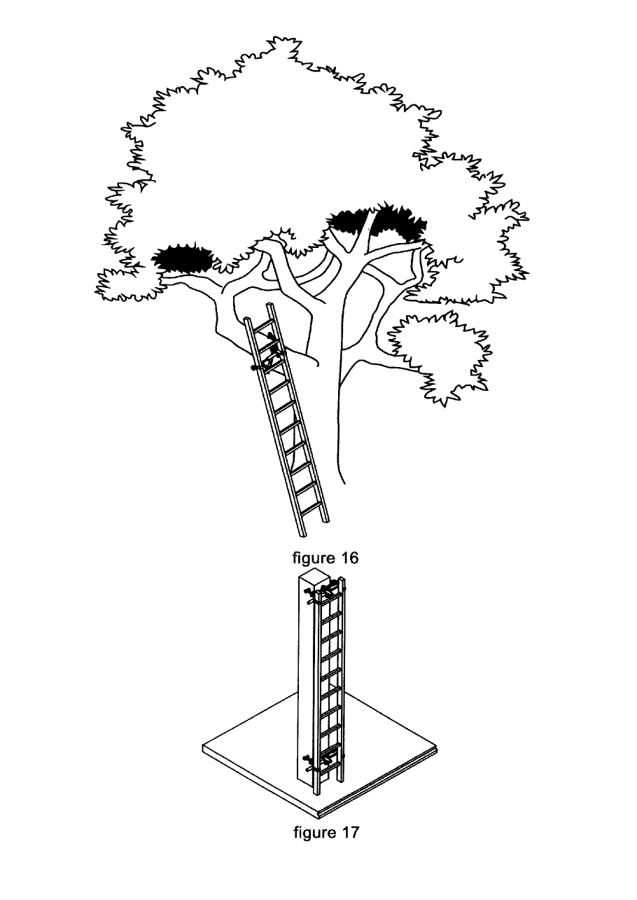

In order to properly secure onto various support articles, a support element (28) (FIGS. 6, 7, 8, 8 and 10) must be placed on the clips (6) (FIG. 3) or (41) (FIG. 11), which is in contact with the support article and permanently secures the whole multi-orientable device. This support element (28) (FIG. 6) is removable and has conventional fastening means (29) (FIG. 6) such as a set screw, quick-release crank, quick-coupling pins or nozzles to connect to the bar (27) (FIG. 3) of the clip (6) (FIG. 3) or (41) (FIG. 11). This support element (28) (FIGS. 6, 7, 8, 9 and 10) is provided with different types of ends to suit the different support articles onto which it can be secured, these ends being:
To secure to rigid support articles and on more or less flat surfaces, the end has a screw (30) (FIG. 6) that is inserted into a threaded hole (31) (FIG. 6) of the support element and one end of the screw is provided with a slip-resistant rubber insert (32) (FIG. 6) affixed thereto.
To secure to support articles with an extensively flat surface, the end has a bar (33) (FIG. 7) arranged perpendicularly to the bar (27) (FIG. 3) of the clip (6), which is provided with threaded holes (34) (FIG. 7) at the ends thereof, into which the screws (35) (FIG. 7) are inserted, which are provided with a slip-resistant, rubber insert (36) (FIG. 7) affixed thereto.
To secure to circular or oval-shaped support articles such as wooden posts or trees, the end has a semicircular projection (37) (FIG. 8), which has at least one tooth (38) (FIG. 8) on the side of the smaller radius.
To secure to support articles made from soft or semi-rigid materials, the end has at least one pointed projection (39) arranged perpendicularly to the bar (27) (FIG. 3) of the clip (6) (FIG. 3).
To secure to various support articles, the end has at least one through-hole (40) (FIG. 10) through which conventional elements such as ropes, chains, wires, flanges or screws can be inserted, for securing to different support articles.

By joining the capacity to secure to objects that are in multiple positions and orientations, along with the different types of tips, this safety device for portable steps can provide a solution for securing in any of these situations. Several examples of application and use of the new multi-orientable device for securing portable steps are shown hereinbelow:
Use for securing the steps on a horizontal plane, such as the floor slab in a building (FIG. 12).
Use for securing the steps on an inclined plane, such as a roof (FIG. 13).
Use for securing the steps on a cylindrical object such as a circular pillar, a post or lamppost (FIG. 14).
Use for securing the steps on a vertical plane, such as a pillar (FIG. 15).
Use for securing the steps on objects having any orientation and variation in dimension, such as a tree (FIG. 16).
Use for securing the steps using two or more multi-orientable devices (FIG. 17).

### BRIEF DESCRIPTION OF THE DRAWINGS

To complement the description made in this invention and for a better understanding of the characteristics of the invention herein, attached to the present descriptive memory, and as an integral part thereof, is a set of drawings and images. These drawings are for the purposes of illustration and non-limiting in manner of the present invention.

### DESCRIPTION OF FIGURES

FIG. 1: Multi-orientable device for securing portable steps (1), portable step (2), support article (3),longitudinal members of the steps (4), cross-members of the steps (5) and fastening clips (6).

FIG. 2: Multi-orientable device for securing portable steps (1), portable step (2), support article (3) and fastening clips (6).

FIG. 3: Fastening clips (6), virtual line that forms the X axis (7), jaws to be secured to the longitudinal members or cross-members of the steps (8), virtual line that forms the Z axis (9), double clamp with holes at 90° (10), X clamp oriented towards the X axis (11), tube on the X axis on which the X clamp (12) slides, worms (13), securing of the X clamp to the tube (14), Z clamp oriented along the Z axis (15), tube on the Z axis along which the Z clamp (16) slides, securing of the Z clamp to the tube (17), virtual line that forms the Y axis (19), through-hole through which the Y bar slides (20), bar on the Y axis along which the clips (21) slide, securing of the Y bar (22), through-hole for the fastening pins of the Y bar (23), guide through-hole for securing the ends (24), securing the tip to the Y bar (25), guides on the tip and Y bar in order to rotate the tip in predefined positions (26) and bar of the clip (27).

FIG. 4: Guides on the tip and Y bar in order to rotate the tip in predefined positions (26).

FIG. 5: Virtual line that forms the X axis (7), virtual line that forms the Z axis (9), X clamp oriented along the X axis (11), Z clamp oriented along the Z axis (15) and rotation shaft (18).

FIG. 6: Support element of the multi-orientable device (28), securing of the tip (29), screw (30), threaded hole (31) and rubber insert (32).

FIG. 7: Support element of the multi-orientable device (28), bar (33), threaded hole (34), screw (35) and rubber insert (36).

FIG. 8: Support element of the multi-orientable device (28), having a semicircular projection (37) and teeth (38).

FIG. 9: Support element of the multi-orientable device (28), and pointed projection (39).

FIG. 10: Support element of the multi-orientable device (28), and through hole (40).

FIG. 11: Clip bar (27), clip (41), bar along which the clips slide(42), flexible connector element (43), securing to the steps (44), flexible element tensioner (45), guide through-hole (46), attachment point (47) and securing of the tip (48).

FIG. 12: Steps with a multi-orientable safety device secured to a horizontal plane.

FIG. 13: Steps with a multi-orientable safety device secured to a sloping plane.

FIG. 14: Steps with a multi-orientable safety device secured to a circular pillar.

FIG. 15: Steps with a multi-orientable safety device secured to a vertical plane.

FIG. 16: Steps with a multi-orientable safety device secured to a tree.

FIG. 17: Steps with two multi-orientable safety devices secured to a rectangular pillar.

### DESCRIPTION OF A PREFERRED EMBODIMENT

One form of a preferred embodiment is cited by way of example, the materials used in the manufacture, shape, size and arrangement of the components being independent from the object of the invention, which are likely to vary as long as this does not alter the essential characteristics of the invention, described in a preferred form.

This multi-orientable device (1) (FIGS. 1 and 2) is affixed to the longitudinal members (4) (FIG. 1) or the cross-members (5) (FIG. 1). The structure and arrangement of the components provide it with the capacity to move and rotate on three Cartesian axes (X, Y, Z) making it possible to position the clips (6) (FIGS. 1 and 2) correctly in order to press the support article (3) (FIGS. 1 and 2), and thereby securing the steps.

To achieve said translational and rotational capacity on three axes (X, Y, Z), and to secure to the steps and the support article, the following means are provided:
Securing the device (1) (FIG. 1) to the steps. The new multi-orientable device is secured by arranging two jaws (8) (FIG. 3), one of which is integrally affixed to the X tube (12) (FIG. 3) and the other is integrally affixed to a worm gear (13) (FIG. 3). By placing these jaws between the longitudinal members or between two rungs and generating the clamping, the device remains secured to the steps.
Translation and rotation on the X axis. This new device has means for moving and rotating the fastening clips (6) (FIG. 3) relative to the X axis (7) (FIG. 3), the X axis being defined by the virtual line formed between the jaws (8) (FIG. 3). The translational and rotational movement relative to the X axis (7) (FIG. 3) of the clips is provided with conventional means such as a double clamp (10) (FIG. 3). The X clamp (11) (FIG. 3) integrally affixed to the double clamp (10) (FIG. 3), is oriented towards the X axis (7) (FIG. 3) and has a clearance fit with the tube (12) (FIG. 3), enabling its translation and rotation relative to the X axis (7) (FIG. 3). The X clamp has conventional fastening means (14) (FIG. 3) such as a set screw, quick-release crank or pins.
Translation and rotation on the Z axis. This new device has means for moving and rotating the fastening clips (6) (FIG. 3) relative to the Z axis (9) (FIG. 3). The translational and rotational movement relative to the Z axis (9) (FIG. 3) of the clips is provided with conventional means such as a double clamp (10) (FIG. 3). The Z clamp (15) (FIG. 3, integrally affixed to the double clamp (10) (FIG. 3), is oriented towards the Z axis (9) (FIG. 3) and has a clearance fit with the Z tube (16) (FIG. 3), enabling its translation and rotation relative to the Z axis (9) (FIG. 3). The Z clamp has conventional fastening means (17) (FIG. 3) such as a set screw, quick-release crank or pins.
Translation and rotation on the Y axis. This new device has means for moving and rotating the fastening clips (6) (FIG. 3) relative to the Y axis (19) (FIG. 3). The translational and rotational movement relative to the Y axis (19) (FIG. 3) of the clips is provided with conventional means such as the Z tube (16) (FIG. 3) that has a through hole (20) (FIG. 3) comprising a clearance fit relative to the circular Y bar (21) (FIG. 3), enabling its translation and rotation relative to the Y axis (19) (FIG. 3), the Z tube being provided with conventional fastening means (22) (FIG. 3) such as a set screw, quick-release crank or pins.
Securing the Y bar. To secure translation in predefined positions and restrict rotation on the Y axis (19) (FIG. 3) and the Y bar (21) (FIG. 3). The multi-orientable device is provided with a Y bar and multiple through holes (23) (FIG. 3), the screw (22) (FIG. 3) acting as a pin, thereby securing the Y bar (21) (FIG. 3) in predetermined positions.
Translation and securing of clips. The clips (6) (FIG. 3) are moved along the Y bar (21) (FIG. 3) to fit the dimensions of the support article (3) (FIG. 1) on which they have to exert pressure, the clips being fixed to the bar to maintain pressure. This translational movement is provided with a guide through-hole (24) (FIG. 3) in the clips, which has a clearance fit relative to the Y bar (21) (FIG. 3), enabling its translation along the Y bar. The clips are secured with a screw (25) (FIG. 3).

In order to properly secure onto rigid supports and on more or less flat surfaces, a support element (29) (FIG. 6) is placed on the clips (6) (FIG. 3) or (41), which is in contact with the support article and permanently secures the whole multi-orientable device. This support element (28) (FIG. 6) is removable and has conventional fastening means (29) (FIG. 6) such as a set screw, quick-release crank, quick-coupling pins or nozzles to connect to the bar (27) (FIG. 3) of the clip (6) (FIG. 3) or (41) (FIG. 11). The end of the support element has a screw (30) (FIG. 6) that is inserted into a threaded hole (31) (FIG. 6) of the support element. The screw is provided with a slip-resistant, rubber insert (32) (FIG. 6) affixed thereto.

1. Removable safety device of the type to be incorporated into the longitudinal members or cross-members of portable steps for securing to different objects, by tightening a number of clips by having a first structure configured for moving and rotating the fastening clips relative to the X axis, the X axis being defined by the virtual line formed between the jaws which are secured by pressing the longitudinal members or cross-members of the portable steps, as it is provided with a second structure configured for moving and rotating the clips relative to the Z axis, the Z axis being defined as a virtual line perpendicular to the X axis, and the translational and rotational movement relative to the X axis of the clips being provided with an X clamp, the X clamp being oriented along the X axis and having a clearance fit relative to the tube, enabling its translation and rotation relative to the X axis, The, the X clamp having a conventional fastener, the translational and rotational movement relative to the Z axis of the clips is provided with a Z clamp, the Z clamp being oriented along the Z axis and comprising a clearance fit relative to the Z tube, enabling its translation and rotation relative to the Z axis, the Z clamp being provided with a conventional fastener, the translation and rotation on the X and Z axes thereby enabling the safety device to direct and place the clips in the best position in relation to the support article.

2. Removable safety device according to claim 1, by varying the angle of X axis and the Z axis, using clamp with a rotation shaft aligned to the center of the X clamp and the Z clamp.

3. Removable safety device according to claim 1 by having a third structure for moving and rotating the fastening clips relative to the Y axis, the Y axis being defined as a virtual line perpendicular to the Z axis, the translational and rotational movement relative to the Y axis of the clips being provided with a conventional device such as the Z tube that has a through hole comprising a clearance fit relative to the circular Y bar, enabling its translation and rotation relative to the Y axis, the Z tube being provided with a conventional fastener.

4. Removable safety device according to claim 3 by being configured for securing the translation and rotation of the Y bar with the Y bar with at least one through-hole, the screw acting as a pin, thereby securing the Y bar in predefined positions and restricting the rotational movement of the clips on the Y axis.

5. Removable safety device according to claim 3 by having a device configured for moving the clips along the Y bar and securing them while allowing transitional movement, this translational movement being provided with a guide through-hole in the clips, which has a clearance fit relative to the Y bar, enabling its translation along the Y bar, and wherein the clips are provided with a fastener.

6. Removable safety device according to claim 5, by having a device configured for providing rotation of the clips relative to the Y axis by guides in predefined positions, said rotation of the clips being provided with at least one guide having an inlet and outlet in the clips and the Y bar.

7. Removable safety device according to claim 1 by having at least one support element that makes contact with an object onto which the steps are secured, said support element being removable and having a fastener to connect to the bar of the clip, the support element having different types of ends for correctly gripping to different objects onto which the safety device is to be secured, including various types of ends integrally attached to the support element;
with a screw inserted into a threaded hole of the support element and one end of the screws, a slip-resistant rubber insert is integrally affixed thereto, said support element being intended to be secured to different articles;
with a bar arranged perpendicularly to the bar of the clip, which bar is provided with threaded holes at the ends thereof, into which the screws are inserted, which screws have a slip-resistant, rubber inserts affixed thereto, the support element being intended to be secured to articles having a flat surface;
with a semicircular projection, which projection has at least one tooth on the side having a smaller radius, the support element being intended to be secured to circular or oval-shaped articles;
with at least one pointed projection arranged perpendicularly to the bar of the clip said support element being intended to be secured to articles made from soft or semi-rigid materials;
with at least one through hole through which conventional elements can be inserted for securing to different support articles.
